(19) United States
(12) Patent Application Publication
(10) Pub. No.: US 2025/0317228 A1
(43) Pub. Date: Oct. 9, 2025

(54) PATHLOSS INFORMATION PROVISIONING

(71) Applicant: Nokia Technologies Oy, Espoo (FI)

(72) Inventors: Timo KOSKELA, Oulu (FI); Juha Pekka KARJALAINEN, Sotkamo (FI); Sami-Jukka HAKOLA, Oulu (FI); Keeth Saliya Jayasinghe LADDU, Espoo (FI)

(73) Assignee: Nokia Technologies Oy, Espoo (FI)

(21) Appl. No.: 19/169,274

(22) Filed: Apr. 3, 2025

(30) Foreign Application Priority Data
Apr. 4, 2024 (FI) 20245402

(51) Int. Cl. H04B 17/309; H04B 7/0413

(52) U.S. Cl. CPC H04B 17/347; H04B 7/0413

(57) ABSTRACT

Example embodiments of the present disclosure relate to apparatuses, methods, devices and computer readable storage medium for pathloss information provisioning. In a method, a first apparatus receives, from a second apparatus, pathloss information for at least one of: a beam switching of the first apparatus, or a transmission from the first apparatus to the second apparatus. The pathloss information comprises at least one of: a pathloss value for the beam switching, or information for determining the pathloss value. The first apparatus performs, based on the pathloss value, at least one of: the beam switching, or the transmission.

### CROSS-REFERENCE TO RELATED APPLICATION

This application claims priority from, and the benefit of, Finland Application No. 20245402, filed Apr. 4, 2024, the contents of which are hereby incorporated by reference in their entirety.

### FIELD

Various example embodiments of the present disclosure generally relate to the field of telecommunication and in particular, to methods, devices, apparatuses and computer readable storage medium for pathloss information provisioning.

### BACKGROUND

With developments in communication systems such as the fifth generation (5G) communication systems and the development in artificial intelligence/machine learning (AI/ML) technologies, a new approach is being explored for the provisioning of pathloss prediction within the third-generation partnership project (3GPP) New Radio (NR) framework. It aims to integrate AI/ML-based beam management, particularly focusing on the prediction of downlink (DL) beam patterns for enhanced Multiple Input Multiple Output (MIMO) operations. Enhancements are proposed to support data collection, model inference, performance monitoring, and the dynamic activation or deactivation of AI/ML functionalities via 3GPP signaling, for both user equipment (UE)-sided and network (NW)-sided models. The approach may optimize beam management by pathloss estimation, therefore, it is worth exploring the AI/ML enhancements for beam management, to improve network efficiency and user experience in 5G systems.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, pathloss information for at least one of: a beam switching of the first apparatus, or a transmission from the first apparatus to the second apparatus, wherein the pathloss information comprises at least one of: a pathloss value, or information for determining the pathloss value; and perform, based on the pathloss value, at least one of: the beam switching, or the transmission.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, pathloss information for at least one of: a beam switching of the first apparatus, or a transmission from the first apparatus to the second apparatus, wherein the pathloss information comprises at least one of: a pathloss value for the beam switching, or information for determining the pathloss value.

In a third aspect of the present disclosure, there is provided a method. The method comprises: receiving, at a first apparatus from a second apparatus, pathloss information for at least one of: a beam switching of the first apparatus, or a transmission from the first apparatus to the second apparatus, wherein the pathloss information comprises at least one of: a pathloss value, or information for determining the pathloss value; and performing, based on the pathloss value, at least one of: the beam switching, or the transmission.

In a fourth aspect of the present disclosure, there is provided a method. The method comprises: transmitting, at a second apparatus to a first apparatus, pathloss information for at least one of: a beam switching of the first apparatus, or a transmission from the first apparatus to the second apparatus, wherein the pathloss information comprises at least one of: a pathloss value for the beam switching, or information for determining the pathloss value.

In a fifth aspect of the present disclosure, there is provided a first apparatus. The first apparatus comprises means for receiving, from a second apparatus, pathloss information for at least one of: a beam switching of the first apparatus, or a transmission from the first apparatus to the second apparatus, wherein the pathloss information comprises at least one of: a pathloss value, or information for determining the pathloss value; and means for performing, based on the pathloss value, at least one of: the beam switching, or the transmission.

In a sixth aspect of the present disclosure, there is provided a second apparatus. The second apparatus comprises means for transmitting, to a first apparatus, pathloss information for at least one of: a beam switching of the first apparatus, or a transmission from the first apparatus to the second apparatus, wherein the pathloss information comprises at least one of: a pathloss value for the beam switching, or information for determining the pathloss value.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow of pathloss information provisioning in accordance with some embodiments of the present disclosure;

FIG. 3 illustrates a flowchart of a method for beam switching based on the pathloss information according to one example embodiment of the present disclosure;

FIG. 4 illustrates a flowchart of a method for transmission based on the pathloss information according to another example embodiment of the present disclosure;

FIG. 5 illustrates a flowchart of a method implemented at a first apparatus in accordance with some example embodiments of the present disclosure;

FIG. 6 illustrates a flowchart of a method implemented at a second apparatus in accordance with some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on a ML technique. The ML techniques may also be referred to as AI techniques. In general, a ML model can be built, which receives input information and makes predictions based on the input information. As used herein, a model is equivalent to an AI/ML model, or a data-driven/data processing algorithm/procedure.

As described above, an AI/ML model may be applied in the NR radio interface to assist model functionalities or communication-related functions. In an example use case, the AI/ML model may be used for channel state information (CSI) feedback enhancement, such as overhead reduction, improved accuracy and prediction. In another example use case, the AI/ML model may be used for beam management, such as beam prediction in time and/or spatial domain for overhead and latency reduction, and/or beam selection accuracy improvement. In a further example use case, the AI/ML model may be used for positioning accuracy enhancements for different scenarios including those with heavy non-line of sight (NLOS) conditions. The AI/ML approaches may be diverged to support various requirements on the gNB-UE levels.

The AI/ML model may be in UE-side or network (NW)-side. For UE-sided model, the UE may perform prediction and report the predicted Set A beam identifier (ID), or reference signal received power (RSRP) or Top-K of Set A beam ID(s)/RSRP in future time steps to the network. For NW-sided model, the NW predict Set A beam IDs/RSRP or Top-K of Set A beam ID(s)/RSRP in future time steps using history of Set B beam measurement reported by UE.

Some mechanisms capture the pathloss RS related switching condition for uplink (UL) transmission configuration indicator (TCI) state switching, using separate UL TCI state or joint TCI state of unified TCI state switch framework.

In case of joint TCI state switch, UE is not expected to transmit on UL before UE completes the downlink (DL) and UL TCI state switching. For separate UL TCI state switch or joint TCI state switch for physical uplink control channel (PUCCH) or physical uplink shared channel (PUSCH), or semi-persistent/aperiodic/periodic sounding reference signal (SRS), when beamCorrespondenceWithoutUL-BeamSweeping is set to 1 , upon receiving physical downlink shared channel (PDSCH) carrying medium access control control element (MAC-CE) activation command in slot n on serving cell.

The UE shall be able to transmit uplink signal with the target TCI state in the slot

$$n + {T}_{HAROQ} + 3 {N}_{slot}^{subframe , μ} + NM ⋆ ( {T}_{fi rst \_ target - PL - RS} + 4 ⋆ {T}_{target\_PL - RS} + 2 ms ) / NR slot length . \qquad ( 1 )$$

If target TCI state is unknown, the UE shall be able to transmit uplink signal with the target TCI state in the slot

$$n + {T}_{HARQ} + 3 {N}_{slot}^{subframe , μ} + ( {T}_{L 1 - RSRP} + {T}_{fi rst \_ target - PL - RS} + 4 ⋆ {T}_{target\_PL - RS} + 2 ms ) / NR slot length , \qquad ( 2 )$$

with the target TCI state in the slot n+T_{HARQ}+3 ms+T_{L1-RSRP}+T_{first_target-PL-RS}+4*T_{target_PL-RS}+2 ms (3).

In the above (1) to (3), T_{HARQ} (in slot) is the timing between DL data transmission and acknowledgement; if the target PL-RS is not maintained by the UE, NM=1, otherwise, NW=0; T_{first_target-PL-RS} is time to first pathloss RS transmission after L1-RSRP measurement when target TCI state is unknown; T_{first_target-PL-RS} is time to first pathloss RS transmission after MAC CE command is decoded by the UE for known TCI State; T_{target_PL-RS} is the periodicity of the target pathloss reference signal which would be SSB or non-zero power (NZP) channel state information reference signal (CSI-RS) when pathloss (PL) reference signal (PL-RS) is associated with serving cell; T_{target_PL-RS} is the periodicity of the target pathloss reference signal which would be SSB when PL-RS is associated with physical cell ID (PCI) different from serving cell; and T_{L1-RSRP} is the time for Rx beam refinement in frequency range 2 (FR2), defined as: T_{L1-RSPR_Measurement_Period_SSB} for SSB, with the assumption of M=1 and T_{Report}=0; T_{L1-RSRP_Measurement_Period_CSI-RS} for CSI-RS, and CSI-RS based L1-RSRP measurement only apply for TCI state switch when source RS is associated with serving cell. T_{L1-RSRP_Measurement_Period_CSI-RS} is configured with higher layer parameter repetition set to ON, and with the assumption of M=1 for periodic CSI-RS and with T_{Report}=0. T_{L1-RSRP_Measurement_Period_CSI-RS} is for aperiodic CSI-RS if number of resources in resource set at least equal to MaxNumberRxBeam. When PL-RS is SSB in FR2, the delay requirement needs to be considered.

Some standards such as release 17 (Rel-17) defined a unified TCI state framework where a common TCI/quasi-colocation (QCL) framework is for both DL and UL. In unified TCI State (Rel-17) framework, a single TCI state can be indicated to UE and this TCI state or rather RS(s) indicated by the TCI State are used for transmission and reception assumptions for physical downlink control channel (PDCCH)/PDSCH/CSI-RS and/or PUCCH/PUSCH/SRS. R18 extended the use of unified TCI framework to all single downlink control information (S-DCI) and multiple downlink control information (M-DCI) multi-transmission and reception point (TRP) DL and UL transmission schemes developed in release 16 to release 18 by allowed UE to have up to two joint DL/UL or separate DL and UL indicated TCI states.

In unified TCI state framework, the beam indication or rather TCI state indication (i.e. indication which TCI state is used for transmission and/or reception assumptions for signals and channels associated with the TCI State) has following steps:

The first step is that for a serving cell, the unified TCI State type is configured to be either joint UL/DL or separate UL/DL. In joint UL/DL the indicated TCI State is used for uplink and downlink, and in separate the DL and UL are indicated separately (one TCI codepoint that is indicated in DCI may comprise DL TCI only, UL TCI only or DL and UL TCI states). If the TCI state type is joint, UE is configured with a single list of TCI states using RRC.

The second step is that if the TCI state type is separate, UE is configured with a DL TCI State list and UL TCI State list. Configuration is done using RRC signaling while MAC CE selects and activates up to eight (in Rel-17) TCI codepoints of which one may become indicated via DCI. As said earlier, one TCI codepoint may comprise DL TCI state only, UL TCI state only or both DL and UL TCI states.

The third step is that, to indicate a TCI state (joint) or separate TCI States (UL and DL) network provides a TCI codepoint (a value in a DCI message) that corresponds to the TCI codepoint in the MAC CE that activated the TCI codepoint(s). Upon receiving the DCI based beam indication (a DCI codepoint) UE applies the indicated TCI States for the indicated channels (PDSCH, PDCCH, PUSCH, or PUCCH).

The IE TCI-State associates one or two DL reference signals with a corresponding QCL type. The TCI-State information element is shown in the following Table. 1.

TABLE 1
-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| additionalPCI-r17 | AdditionalPCIIndex-r17 | OPTIONAL, -- Need R |
|---|---|---|
| pathlossReferenceRS-Id-r17 | Pathloss ReferenceRS-Id-r17 | OPTIONAL, |
| | -- Cond JointTCI1 | |
| ul-powerControl-r17 | Uplink-powerControlId-r17 | OPTIONAL |

-- Cond JointTCI

]]
}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS-Indicated |

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

The QCL-Info field descriptions are shown in the following Table. 2.

TABLE 2
QCL-Info field descriptions

bwp-Id
The DL BWP which the RS is located in. If the field is absent, the RS is located
in the DL BWP in which the TCI-State is applied by the UE.
cell
The UE's serving cell in which the referenceSignal is configured. If the field is
absent, it applies to the serving cell in which the TCI-State is applied by the UE.
The RS can be located on a serving cell other than the serving cell for which the
TCI-State is applied by the UE only if the qcl-Type is configured as typeC or
typeD. If the referenceSignal is set to csi-rs and unifiedTCI-StateType is
configured, either both cell and bwp-Id are present or both cell and bwp-Id are
absent.
referenceSignal
Reference signal with which quasi-collocation information is provided as
specified in a predefined standard.
TCI-State field descriptions
additionalPCI
Indicates the physical cell IDs (PCI) of the SSBs when referenceSignal is
configured as SSB for both QCL-Type1 and QCL-Type2. In case the cell is
present, the additionalPCI refers to a PCI value configured in the list configured
using additionalPCI-ToAddModList in the serving cell indicated by the field cell.
Otherwise, it refers to a PCI value configured in a list additionalPCI-
ToAddModList configured in the serving cell where the TCI-State is applied by
the UE. When this field is present the cell for qcl-Type1 and qcl-Type2 is
configured with same value, if present.
pathlossReferenceRS-Id
The ID of the reference signal (e.g. a CSI-RS or an SS block) used for PUSCH,
PUCCH and SRS pathloss estimation. This field refers to an element in the list
configured using pathlossReferenceRSToAddModList in the serving cell and UL
BWP where the TCI State is applied by the UE.
qcl-Type1, qcl-Type2
QCL information for the TCI state as specified in a predefined standard.
tci-StateId
ID number of the TCI state.
ul-PowerControl
Configures power control parameters for PUCCH, PUSCH and SRS for this TCI
state. The field is present here only if ul-powerControl is not configured in any
BWP-Uplink-Dedicated of this serving cell. This field refers to an element in the
list configured using uplink-PowerControlToAddModList in the serving cell
where the dl-OrJointTCI-StateToAddModList is configured.

The conditional presence and explanations are shown in the following Table. 3.

TABLE 3

| Conditional | |
|---|---|
| Presence | Explanation |
| CSI-RS-Indicated | This field is mandatory present if csi-rs is included and |
| | unifiedTCI-StateType is not configured. This field is |
| | optionally present, Need R, if csi-rs is included and |
| | unifiedTCI-StateType is configured. Otherwise, it is |
| | absent, Need R. |
| JointTCI | This field is optionally present, Need R, if this serving cell |
| | is configured with unifiedTCI-StateType set to ‘joint’. It is |
| | absent, Need R, otherwise. |
| JointTCI | This field is mandatory present, if this serving cell is |
| | configured with unifiedTCI-StateType set to ‘joint’. It is |
| | absent, Need R, otherwise. |

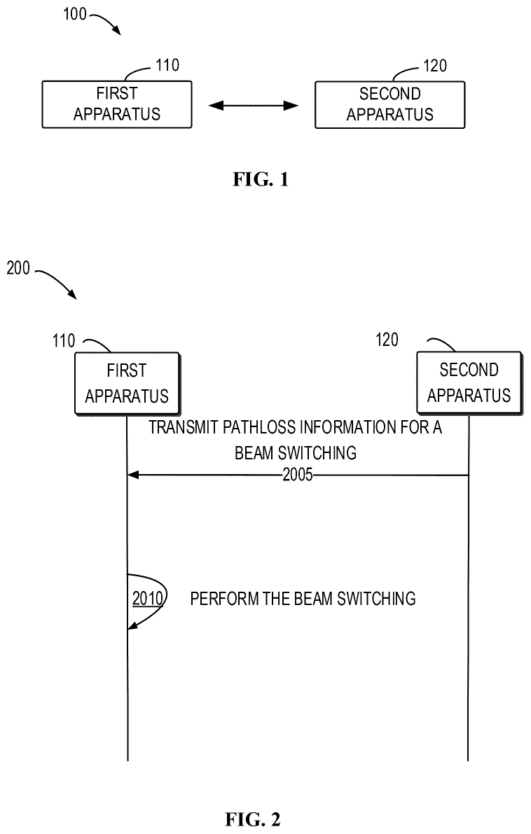

FIG. 1 illustrates an example communication environment 100 in which example embodiments of the present disclosure may be implemented. As shown in FIG. 1, the communication network 100 may include a first apparatus 110 and a second apparatus 120. The first apparatus 110 may communicate with the second apparatus 120. An AI/ML model may be deployed at the second apparatus 120. The AI/ML model may be used for any suitable use cases or to implement any suitable functionalities, including but not limited to, channel state information (CSI) prediction, beam management (BM) (also referred to as beam prediction), positioning, etc. By way of example, an AI/ML model may be implemented at the second apparatus 120, or the first apparatus 110. Alternatively, a part of the AI/ML model may be implemented at the second apparatus 120, or the first apparatus 110. The AI/ML model (also referred to as a “model”) may provide a communication functionality. In the following description, some example embodiments will be described with the model implemented at the second apparatus 120.

It is to be understood that the number of second apparatus and first apparatus shown in FIG. 1 is given for the purpose of illustration without suggesting any limitations. The communication network 100 may include any suitable number of second apparatus and first apparatus.

As used herein, the term “communication functionality” may refer to a functionality or service provided by the AI/ML model. The term “communication functionality” may also be referred to as a “AI/ML based functionality” or “AI/ML enabled functionality” or “AI/ML based use case”.

In some example embodiments, the first apparatus 110 may include a network device (for example, a gNB), and the second apparatus 120 may include a terminal device (for example, a UE). In the following, for the purpose of illustration, some example embodiments are described with the first apparatus 110 operating as a network device and the second apparatus 120 operating as a terminal device. However, in some example embodiments, operations described in connection with a terminal device may be implemented at a network device or other device, and operations described in connection with a network device may be implemented at a terminal device or other device.

In some example embodiments, if the first apparatus 110 is a network device and the second apparatus 120 is a terminal device, a link from the second apparatus 120 to the first apparatus 110 is referred to as an uplink (UL), and a link from the first apparatus 110 to the second apparatus 120 is referred to as a downlink (DL). In UL, the second apparatus 120 is a transmitting (TX) device (or a transmitter) and the first apparatus 110 is a receiving (RX) device (or a receiver). In DL, the first apparatus 110 is a TX device (or a transmitter) and the second apparatus 120 is a RX device (or a receiver).

The AI/ML based beam management may be spatial and/or time domain beam prediction. The spatial beam prediction (also referred to as BM-Case1) is to predict one or more best Tx beams or Tx-Rx beam pairs or corresponding reference signal received power (RSRP) values in different spatial locations. The BM-Case1 is spatial-domain DL beam prediction for Set A of beams based on measurement results of Set B of beams. The time-domain beam predictions (also referred to as BM-Case2) aim to predict the best Tx beams or Tx-Rx beam pairs to use for next time instants, e.g., beam prediction in the spatial domain (BM-Case1) for next time instants. The BM-Case2 is temporal DL beam prediction for Set A of beams based on the historic measurement results of Set B of beams. For purpose of illustration, some example embodiments are described where the model functionality is the spatial and/or time domain beam prediction.

During Rel-18 AI/ML study item, for BM-Case1, there is an agreement related to how to perform beam indication of beams in Set A not in Set B. There is also another agreement related to beam indication from network for UE reception. The observation is that, at least for BM-Case1 with a UE-side AI/ML model, for AI model inference, the legacy TCI state mechanism can be used to perform beam indication of beams.

In some example embodiments, in time domain beam prediction (TBP), the outcome of the prediction or the prediction output may be predicted as a sequence of outputs in multiple sequential time steps. For example, the model may perform training or run the inference to predict Set A beams or Top-K of Set A beams in future time instants. The Set A beams may be referred to as a set of candidate beams. Top-K of Set A beams may be a subset of Set A beams. The at least one predicted beam, at least one predicted first beam, and/or at least one predicted second beam may be the predicted Set A or a subset of Set A.

Historical measurement results of Set B beams may be used to predict Set A beams. In an example, Set B beams may be subset of Set A. In another example, Set B may be different from Set A. For example, Set B represents set of wide beams and Set A represents set of narrow beams. In a further example, Set B beams may be the same as Set A beams.

In some example embodiments, one or more models may derive an outcome such as the predicted beam of the beam management. The one or more models may be implemented at the second apparatus 120 (not shown). The second apparatus 120 may perform the beam management by running inference or perform training. For purpose of illustration, some example embodiments hereinafter will be described with the model implemented at the second apparatus 120.

In the example of FIG. 1, by using the model, the second apparatus 120 may use beam measurement results of M historical time instances to predict future beam(s) of N future time instances, where M is larger than one and N is larger than or equal to one. The beam measurement results of M historical time instances refer to measurement results of M latest measurement instances, which are used as input of the model. The output of the model is N predictions for N future time instances, where each prediction corresponds to one future time instance and may comprise one or more predicted beams.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In TCI state switching to the new UL TCI State (in case of both joint DL/UL or separate DL/UL), the UE may require additional time for estimating the pathloss associated with the target TCI State. This means that both network and UE is not able to switch to the to target TCI state when Pathloss measurement time has to be assumed for the UE. Typically, UE may maintain pathloss estimate to limited set of reference signals but in prediction based (NW prediction) beam switching the UE may be switched to target TCI state it has not measured and/or not maintained a pathloss.

In order to solve at least part of the above problems or other potential problems, a solution on pathloss information provisioning is proposed. In the solution, a second apparatus such as a network device provides a first apparatus such as a terminal device the (predicted) pathloss information for the beam switching or a transmission from the first apparatus to the second apparatus (such as a uplink transmission). For example, the pathloss information may include a pathloss value such as a predicted pathloss value. For another example, the pathloss information may include information for determining the pathloss value. The pathloss information may be associated with RS. Based on the pathloss information, the first apparatus performs the beam switching and/or the transmission to the second apparatus. That is, the pathloss information may be applied for (prediction based and non-prediction based) beam switching to a target beam, e.g. UL/joint TCI state ID. The pathloss information may also be applied for UL transmission. The solution of the present disclosure can increase throughput due to faster switch for target UL/or joint TCI state (beam).

Example embodiments of the present disclosure will be described in detail below with reference to the accompanying drawings.

FIG. 2 illustrates a signaling flow 200 of performing the beam switching in accordance with some embodiments of the present disclosure. For purpose of discussion, some example embodiments are described where the first apparatus 110 is implemented as a terminal device and the second apparatus 120 is implemented as a network device.

In operation, the first apparatus 110 receives (2005), from the second apparatus 120, pathloss information for at least one of: a beam switching of the first apparatus 110, or a transmission from the first apparatus 110 to the second apparatus 120 such as an uplink transmission. In other words, the second apparatus 120 transmits (2005) the pathloss information to the first apparatus 110. In an example embodiment, pathloss information include a pathloss value. The transmission of the pathloss information may be via any suitable signaling, including but not limited to DCI, MAC CE or RRC.

Alternatively, or in addition, the pathloss information may include information for determining the pathloss value (also referred to as “information related to deriving the pathloss”), such as at least one measurement result of at least one RS, such as reference signal received power (RSRP). The first apparatus 110 may determine the pathloss value based on the information.

The first apparatus 110 performs (2010) the beam switching and/or the transmission to the second apparatus 120 based on the pathloss information.

In some example embodiments, the pathloss information is associated with at least one of: at least one reference signal, at least one transmission configuration indicator (TCI) state for the beam switching, a pathloss reference signal (PL-RS)_associated with a target TCI state to be switched to, at least one reference signal included in a TCI state used for pathloss estimation, a set of reference signals for pathloss estimation, or a set of reference signals associated with at least one TCI state.

In some example embodiments, the second apparatus 120 may indicate to the first apparatus 110 the pathloss value (or pathloss information or information related to deriving the pathloss) corresponding to the one or more RSs (for example, Synchronization Signal Block (SSB) or CSI-RS). In some example embodiments, a pathloss value may be associated with TCI state switching i.e. pathloss estimation may associate with one or more TCI state for switching (i.e. the Radio Resource Control (RRC) configured list of TCI States), Pathloss RS included in the target TCI State, RS included in the TCI used for PL estimate, set of reference signals, set of RS specific for PL usage or set of RS associated with TCI States (joint UL/DL or separate UL/DL).

In some example embodiments, the first apparatus 110 may perform the derivation of a path loss value based on path loss information and/or apply power control and/or transmission power for uplink transmission based on path loss value or path loss information.

In any of the example embodiments pathloss value may be used interchangeably with pathloss information or information related to deriving the pathloss value.

In some example embodiments, the indicated/provided path loss value to the first apparatus 110 may comprise of the path loss value (e.g. in dBs), or pathloss information. Path loss information may refer to information related (e.g. RSRP value) to deriving the pathloss value with respect to the at least one reference signal. In some examples the

In some example embodiments, the or pathloss information may comprise of provisioning of (L1-)RSRP value that may be used to derive a path loss value.

In some example embodiments the first apparatus 110 may indicate whether it is capable of deriving a path loss value based on the path loss information (for at least one reference signal).

In some example embodiments, the path loss value or the path loss information may be used by the first apparatus 110 to derive path loss value may be used for at least one uplink transmission associated with at least one DL RS.

In some example embodiments, the path loss value or the path loss information may be used by the first apparatus 110 to apply uplink power control for an uplink transmission. The uplink power control for an uplink transmission may be applied with respect to the at least one DL RS.

In some example embodiments, the path loss value or the path loss information may be used by the first apparatus 110 to derive path loss value may be used to apply uplink transmission power for the uplink transmission.

In some example embodiments, the uplink transmission may refer to at least one of the following: scheduling request transmission, PUSCH transmission, PUCCH transmission, SRS (sounding reference signal transmission), PRACH (Physical random access channel) transmission, Random access preamble transmission. Uplink transmission may be performed by the first apparatus 110.

In some example embodiments, a provided pathloss value (by network) may associated with one or more RS(s) included in TCI state or TCI state ID.

In some example embodiments, the pathloss value may include at least one absolute pathloss value. That is, the network may provide the UE the pathloss value that is absolute value.

Alternatively, in some example embodiments, the pathloss value may include at least one of relative pathloss value. The at least one relative pathloss value may be relative to the at least one absolute pathloss value, relative to a current pathloss value applied by the first apparatus 110, or relative to a previously provisioned pathloss value.

The pathloss value may alternatively or additionally include at least one quantized relative pathloss value with respect to a reference pathloss value and the reference pathloss value. For example, the first apparatus 110 may be indicated with quantized pathloss estimates via downlink signaling which consist of quantized relative pathloss estimates with respect to a specific reference pathloss values as well as the specific quantized pathloss value.

In some example embodiments, the reference pathloss value is associated with a first transmission configuration indicator (TCI) state. For example, an index of first the TCI state may be the lowest among a plurality of indexes of a plurality of TCI states.

In some example embodiments, the lowest indicated TCI state ID works as a reference TCI state associated with a specific reference pathloss estimate value (i.e. the PL of specific TCI state ID is used as reference), and the relative pathloss estimate values associated with other indicated TCI states may be determined with respect to the specific reference pathloss estimate.

In some example embodiments, the reference pathloss value is quantized with a first number of bits with a first step size, and the quantized relative pathloss value is quantized with a second number of bits with a second step size, and the second number is less than or equal to the first number, and the second step size is less than or equal to the first step size.

By way of example, the reference pathloss estimate value in dB is quantized with N-bits with K dB step size, whereas relative pathloss estimates are quantized with M-bits (M<=N) with L dB step size (L<=N).

In some example embodiments, the reference pathloss value of the first TCI state is a largest estimated pathloss value among a plurality of estimated pathloss values for at least one TCI state including the first TCI state.

Alternatively, the lowest indicated TCI state ID works as a reference TCI state associated with a specific reference pathloss estimate value which is the largest pathloss estimate value. Relative pathloss estimate are determined similarly as in the above example embodiments.

In some example embodiments, the first apparatus 110 transmits, to the second apparatus 120, an indication of a capability of applying the pathloss information for performing the beam switching. Alternatively, or in addition, the indication may include a capability of applying the pathloss information for a transmission to the second apparatus 120.

In some example embodiments, the UE may indicate whether it is able or has capability to apply network indicated pathloss value or network indicated information derive the pathloss value for one or more RS, for performing TCI state switching. In some other embodiments, for uplink transmission (SRS, PUCCH/PUSCH or the like).

In some example embodiments, the first apparatus 110 performs a transmission to the second apparatus 120 with a target transmission configuration indicator state associated with the beam switching, wherein at least one pathloss measurement component is excluded from a determination of a delay for the beam switching.

In some example embodiments, if the first apparatus 110 has indicated that is able to use the network provided PL value (or information to derive the pathloss value) for TCI state switching and/or if the network has provided the UE with a PL value associated with the target TCI state, the first apparatus 110 is capable of transmitting the first UL signal/channel with target TCI state excluding at least one pathloss estimation related component that contributes to the delay calculation. In an example embodiment, the at least one pathloss measurement component may include a periodicity of a pathloss reference signal, such as 4*T_{target_PL-RS} in (1) described above. Alternatively, or in addition, in an example embodiment, the at least one pathloss measurement component may include a time duration from a measurement of a RS to a transmission of the pathloss reference signal, or a time duration from coding a command (such a MAC CE command) from the second apparatus 120 for the beam switching to the transmission of the pathloss reference signal, such as T_{first_target-PL-RS} in (1) described above.

In some example embodiments, the pathloss measurement component is used for a determination of the delay for the beam switching if the pathloss information is not received from the second apparatus 120. For example, if the network has not provided the UE with a PL value (or information related for estimating the pathloss) associated with target TCI state, the UE (and the network) assumes TCI state switching delay that includes the at least one PL measurement component.

In some example embodiments, the pathloss value is associated with at least one target transmission configuration indicator (TCI) state to be switched to. In some example embodiments, the downlink control message (DCI or MAC CE) indicating a TCI state switch may provide a PL value associated with the target TCI State for which the first apparatus 110 switched.

Alternatively, in some example embodiments, the downlink control message (DCI or MAC CE) indicating a TCI state switch may provide a (one or more) PL value associated with the sequence of target TCI States for which the first apparatus 110 switched (temporal beam prediction).

In some example embodiments, the downlink control message (DCI or MAC CE) indicating a TCI state switch may provide one or more PL values associated with the sequence of one or more target TCI States for which the UE switched (temporal beam prediction). In some example embodiments, the one PL value may be associated with one or more TCI states.

In some example embodiments, the pathloss information is included in a message indicating at least one of: an activation of a target TCI state, or a switching to the target TCI state.

In some example embodiments, the pathloss value may be provided to the first apparatus 110 to be utilized as part of the signaling indicating an activation or switch to a target TCI state.

In some example embodiments, the pathloss information is included in a message, and the message includes an identifier of a reference signal and the pathloss value associated with the reference signal. The message may be a dedicated control message for transmitting the pathloss information.

In some example embodiments, the pathloss value may be provided to the first apparatus 110, associated with at least one downlink RS. In some example embodiments, the pathloss value may be provided to the first apparatus 110 in a dedicated control message. The control message may comprise at least one of: DL RS identifier (ID) and associated pathloss value or information that may be used by the UE to derive pathloss. This information may be e.g. RSRP value.

In some example embodiments, the pathloss value may be determined by an artificial intelligence/machine learning (AI/ML) model, such as a model implemented at the second apparatus 120.

In some example embodiments, the provided pathloss value may be determined based on prediction (e.g. using ML model such as neural network) by the second apparatus 120. In some example embodiments, the prediction of PL may be performed using machine learning model such as neural network.

In some example embodiments, the second apparatus 120 receives, from the first apparatus 110, measurements of a set of reference signals. The second apparatus 120 may perform a pathloss estimation for at least one reference signal associated with at least one TCI state based on the measurements. The second apparatus 120 may determine the pathloss information based on the pathloss estimation.

By way of example, the network may perform PL estimation for at least one RS associated with at least one TCI state based on the set B of reference signal measurements reported by the UE (set B may refer to the input set of reference signals measurements for the ML model/predictor).

In some example embodiments, the downlink control message (DCI or MAC CE) may be used to signal a PL value that the first apparatus 110 applies upon receiving the downlink control message.

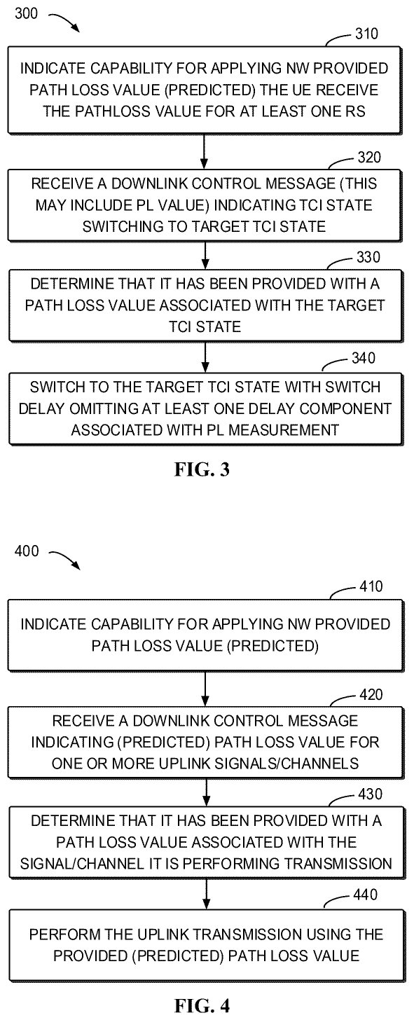

Several example embodiments regarding provisioning the pathloss information and applying the pathloss information for beam switching and transmission have been described. With these embodiments, the throughput can be increased due to faster switch for the target UL or joint TCI state (or beam). Further embodiments regarding performing the beam switching or uplink transmission based on the pathloss information will be described with respect to FIG. 3 and FIG. 4.

FIG. 3 shows a flowchart of a method 300 for beam switching based on the pathloss information according to one example embodiment of the present disclosure. For the purpose of discussion, the method 300 will be described from the perspective of the first apparatus 110 in FIG. 1. In the description of FIG. 3, it is assumed that the first apparatus 110 may be a terminal device and the second apparatus 120 may be a network device. It is to be understood that it is not limited in this regard in the present disclosure.

At block 310, the first apparatus 110 may indicate capability for applying NW provided pathloss value (predicted). For example, the pathloss value may be applied by the first apparatus 110 for beam switching. In addition, at block 310, the first apparatus 110 may receive the pathloss value for at least one RS.

At block 320, the first apparatus 110 receives a downlink control message (this may include PL value) indicating TCI state switching to target TCI state.

At block 330, the first apparatus 110 may determine that the first apparatus 110 has been provided with a pathloss value associated with the target TCI state.

At block 340, the first apparatus 110 switches to the target TCI state with a switch delay omitting at least one delay component associated with PL measurement. The delay component may be 4*Ttarget_PL-RS and/or Tfirst_target-PL-RS.

In this way, the switching time for TCI state changing or beam switching can be reduced. Thus, throughput can be increased due to the faster switching for target UL or joint TCI state.

FIG. 4 shows a flowchart of a method 400 for transmission based on the pathloss information according to another example embodiment of the present disclosure. For the purpose of discussion, the method 400 will be described from the perspective of the first apparatus 110 in FIG. 1. In the description of FIG. 4, it is assumed that the first apparatus 110 may be a terminal device and the second apparatus 120 may be a network device. It is to be understood that it is not limited in this regard in the present disclosure.

At block 410, the first apparatus 110 may indicate capability for applying NW provided pathloss value (predicted). For example, the capability may be applying the pathloss value for uplink transmission to the second apparatus 120.

At block 420, the first apparatus 110 receives a downlink control message indicating (predicted) pathloss value for one or more uplink signals/channels.

At block 430, the first apparatus 110 determines that the first apparatus 110 has been provided with a pathloss value associated with the signal/channel it is performing transmission.

At block 440, the first apparatus 110 performs the uplink transmission using the provided (predicted) pathloss value.

In this way, uplink transmission can be performed based on the pathloss value provided by NW. Thus, throughput can be increased due to the faster uplink transmission.

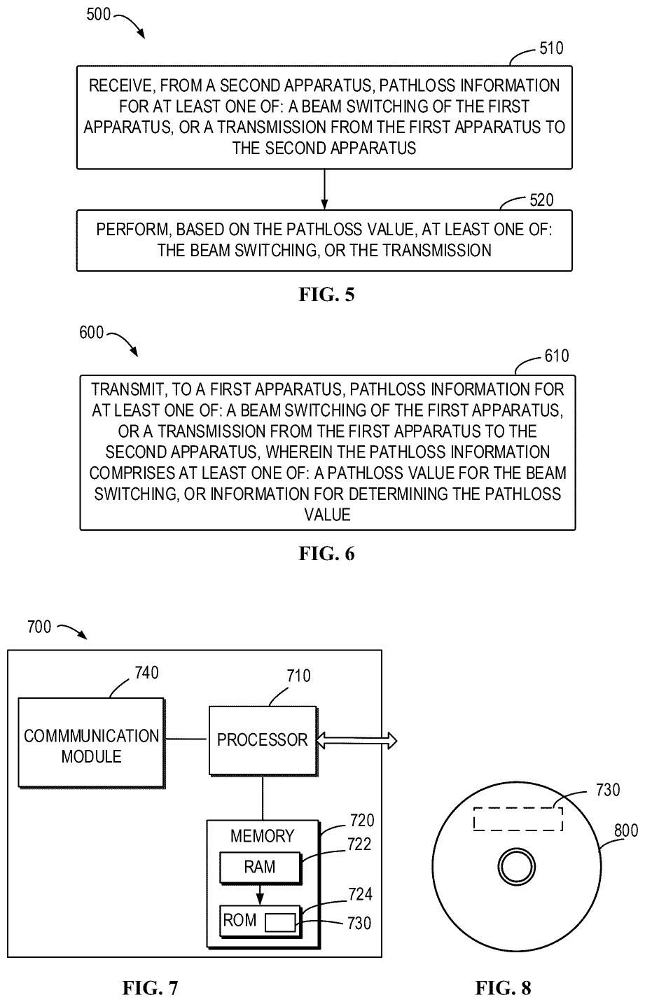

FIG. 5 shows a flowchart of an example method 500 implemented at a first apparatus, in accordance with some example embodiments of the present disclosure. For the purpose of discussion, the method 500 will be described from the perspective of the first apparatus 110 in FIG. 1.

At block 510, the first apparatus 110 receives, from a second apparatus, pathloss information for at least one of: a beam switching of the first apparatus 110, or a transmission from the first apparatus 110 to the second apparatus. The pathloss information comprises at least one of: a pathloss value, or information for determining the pathloss value.

At block 520, the first apparatus 110 performs, based on the pathloss value, at least one of: the beam switching, or the transmission.

In some example embodiments, the pathloss information is associated with at least one of: at least one reference signal, at least one transmission configuration indicator (TCI) state for at least one of the beam switching, or the transmission, a pathloss reference signal associated with a target TCI state to be switched to, at least one reference signal included in a TCI state used for pathloss estimation, a set of reference signals for pathloss estimation, or a set of reference signals associated with at least one TCI state.

In some example embodiments, the pathloss value comprises at least one of: at least one absolute pathloss value for the at least one of the beam switching or the transmission, at least one relative pathloss value relative to the at least one absolute pathloss value, at least one relative pathloss value relative to a current pathloss value applied by the first apparatus, at least one relative pathloss value relative to a previously provisioned pathloss value, or at least one quantized relative pathloss value with respect to a reference pathloss value and the reference pathloss value.

In some example embodiments, the reference pathloss value is associated with a first TCI state. An index of first the TCI state may be lowest among a plurality of indexes of a plurality of TCI states.

In some example embodiments, the reference pathloss value is quantized with a first number of bits with a first step size, and the quantized relative pathloss value is quantized with a second number of bits with a second step size, wherein the second number is less than or equal to the first number, and the second step size is less than or equal to the first step size.

In some example embodiments, the reference pathloss value of the first TCI state is a largest estimated pathloss value among a plurality of estimated pathloss values for at least one TCI state including the first TCI state.

In some example embodiments, the information for determining the pathloss value comprises at least one measurement result of at least one reference signal. The method 500 may further comprise: determining the pathloss value based on the information.

In some example embodiments, the method 500 further comprises: transmitting, to the second apparatus, an indication of a capability of applying the pathloss information for performing at least one of: the beam switching, or a transmission to the second apparatus.

In some example embodiments, the method 500 further comprises: performing a transmission to the second apparatus with a target transmission configuration indicator state associated with the beam switching, wherein at least one pathloss measurement component is excluded from a determination of a delay for the beam switching.

In some example embodiments, the at least one pathloss measurement component is used for a determination of the delay for the beam switching if the pathloss information is not received from the second apparatus.

In some example embodiments, the at least one pathloss measurement component comprises at least one of: a periodicity of a pathloss reference signal for the beam switching, a time duration from a measurement of a reference signal to a transmission of the pathloss reference signal, or a time duration from coding a command from the second apparatus for the beam switching to the transmission of the pathloss reference signal.

In some example embodiments, the pathloss value is associated with at least one target transmission configuration indicator (TCI) state to be switched to.

In some example embodiments, the pathloss information is included in a message indicating at least one of: an activation of a target transmission configuration indicator (TCI) state, or a switching to the target TCI state.

In some example embodiments, the pathloss information is included in a message, the message comprising an identifier of a reference signal and the pathloss value associated with the reference signal.

In some example embodiments, the pathloss value is determined by an AI/ML model.

FIG. 6 shows a flowchart of an example method 600 implemented at a second apparatus, in accordance with some example embodiments of the present disclosure. For the purpose of discussion, the method 600 will be described from the perspective of the second apparatus 120 in FIG. 1.

At block 610, the second apparatus 120 transmits, to a first apparatus, pathloss information for at least one of: a beam switching of the first apparatus, or a transmission from the first apparatus to the second apparatus 120, wherein the pathloss information comprises at least one of: a pathloss value for the beam switching, or information for determining the pathloss value.

In some example embodiments, the pathloss information is associated with at least one of: at least one reference signal, at least one transmission configuration indicator (TCI) state for at least one of the beam switching, or the transmission, a pathloss reference signal associated with a target TCI state to be switched to, at least one reference signal included in a TCI state used for pathloss estimation, a set of reference signals for pathloss estimation, or a set of reference signals associated with at least one TCI state.

In some example embodiments, the pathloss value comprises at least one of: at least one absolute pathloss value for at least one of the beam switching, or the transmission, at least one relative pathloss value relative to the at least one absolute pathloss value, at least one relative pathloss value relative to a current pathloss value applied by the first apparatus, at least one relative pathloss value relative to a previously provisioned pathloss value, or at least one quantized relative pathloss value with respect to a reference pathloss value and the reference pathloss value.

In some example embodiments, the reference pathloss value is associated with a first transmission configuration indicator (TCI) state.

In some example embodiments, an index of first the TCI state is lowest among a plurality of indexes of a plurality of TCI states.

In some example embodiments, the reference pathloss value is quantized with a first number of bits with a first step size, and the quantized relative pathloss value is quantized with a second number of bits with a second step size, wherein the second number is less than or equal to the first number, and the second step size is less than or equal to the first step size.

In some example embodiments, the reference pathloss value of the first TCI state is a largest estimated pathloss value among a plurality of estimated pathloss values for at least one TCI state including the first TCI state.

In some example embodiments, the information for determining the pathloss value may include at least one measurement result of at least one reference signal.

In some example embodiments, the method 600 further comprises: receiving, from the first apparatus, an indication of a capability of applying the pathloss information for at least one of: performing the beam switching, or a transmission to the second apparatus.

In some example embodiments, the pathloss value is associated with at least one target transmission configuration indicator (TCI) state to be switched to.

In some example embodiments, the pathloss information is included in a message indicating at least one of: an activation of a target transmission configuration indicator (TCI) state, or a switching to the target TCI state.

In some example embodiments, the pathloss information is included in a message, the message comprising an identifier of a reference signal and the pathloss value associated with the reference signal.

In some example embodiments, the pathloss value is determined by an artificial intelligence/machine learning (AI/ML) model.

In some example embodiments, the method 600 further comprises: receiving, from the first apparatus, measurements of a set of reference signals; performing a pathloss estimation for at least one reference signal associated with at least one transmission configuration indicator (TCI) state based on the measurements; and determining the pathloss information based on the pathloss estimation.

In some example embodiments, a first apparatus, capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, pathloss information for at least one of: a beam switching of the first apparatus, or a transmission from the first apparatus to the second apparatus, wherein the pathloss information comprises at least one of: a pathloss value, or information for determining the pathloss value; and means for performing, based on the pathloss value, at least one of: the beam switching, or the transmission.

In some example embodiments, the pathloss information is associated with at least one of: at least one reference signal, at least one transmission configuration indicator (TCI) state for at least one of the beam switching, or the transmission, a pathloss reference signal associated with a target TCI state to be switched to, at least one reference signal included in a TCI state used for pathloss estimation, a set of reference signals for pathloss estimation, or a set of reference signals associated with at least one TCI state.

In some example embodiments, the pathloss value comprises at least one of: at least one absolute pathloss value for the at least one of the beam switching or the transmission, at least one relative pathloss value relative to the at least one absolute pathloss value, at least one relative pathloss value relative to a current pathloss value applied by the first apparatus, at least one relative pathloss value relative to a previously provisioned pathloss value, or at least one quantized relative pathloss value with respect to a reference pathloss value and the reference pathloss value.

In some example embodiments, the reference pathloss value is associated with a first transmission configuration indicator (TCI) state.

In some example embodiments, an index of first the TCI state is lowest among a plurality of indexes of a plurality of TCI states.

In some example embodiments, the reference pathloss value is quantized with a first number of bits with a first step size, and the quantized relative pathloss value is quantized with a second number of bits with a second step size, wherein the second number is less than or equal to the first number, and the second step size is less than or equal to the first step size.

In some example embodiments, the reference pathloss value of the first TCI state is a largest estimated pathloss value among a plurality of estimated pathloss values for at least one TCI state including the first TCI state.

In some example embodiments, the first apparatus further comprises: means for determining the pathloss value based on the information.

In some example embodiments, the first apparatus further comprises: means for transmitting, to the second apparatus, an indication of a capability of applying the pathloss information for performing at least one of: means for thing beam switching, or means for thing transmission to the second apparatus.

In some example embodiments, the first apparatus further comprises: means for performing the transmission to the second apparatus with a target transmission configuration indicator state associated with the beam switching, wherein at least one pathloss measurement component is excluded from a determination of a delay for the beam switching.

In some example embodiments, the at least one pathloss measurement component is used for a determination of the delay for the beam switching if the pathloss information is not received from the second apparatus.

In some example embodiments, the at least one pathloss measurement component comprises at least one of: a periodicity of a pathloss reference signal, a time duration from a measurement of a reference signal to a transmission of the pathloss reference signal, or a time duration from coding a command from the second apparatus for the beam switching to the transmission of the pathloss reference signal.

In some example embodiments, the pathloss value is associated with at least one target transmission configuration indicator (TCI) state to be switched to.

In some example embodiments, the pathloss information is included in a message indicating at least one of: an activation of a target transmission configuration indicator (TCI) state, or a switching to the target TCI state.

In some example embodiments, the pathloss information is included in a message, the message comprising an identifier of a reference signal and the pathloss value associated with the reference signal.

In some example embodiments, the pathloss value is determined by an artificial intelligence/machine learning (AI/ML) model.

In some example embodiments, a second apparatus, capable of performing any of the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, pathloss information for at least one of: a beam switching of the first apparatus, or a transmission from the first apparatus to the second apparatus, wherein the pathloss information comprises at least one of: a pathloss value for the beam switching, or information for determining the pathloss value.

In some example embodiments, the pathloss information is associated with at least one of: at least one reference signal, at least one transmission configuration indicator (TCI) state for at least one of the beam switching, or the transmission, a pathloss reference signal associated with a target TCI state to be switched to, at least one reference signal included in a TCI state used for pathloss estimation, a set of reference signals for pathloss estimation, or a set of reference signals associated with at least one TCI state.

In some example embodiments, the pathloss value comprises at least one of: at least one absolute pathloss value for the at least one of the beam switching or the transmission, at least one relative pathloss value relative to the at least one absolute pathloss value, at least one relative pathloss value relative to a current pathloss value applied by the first apparatus, at least one relative pathloss value relative to a previously provisioned pathloss value, or at least one quantized relative pathloss value with respect to a reference pathloss value and the reference pathloss value.

In some example embodiments, the reference pathloss value is associated with a first transmission configuration indicator (TCI) state.

In some example embodiments, an index of first the TCI state is lowest among a plurality of indexes of a plurality of TCI states.

In some example embodiments, the reference pathloss value is quantized with a first number of bits with a first step size, and the quantized relative pathloss value is quantized with a second number of bits with a second step size, wherein the second number is less than or equal to the first number, and the second step size is less than or equal to the first step size.

In some example embodiments, the reference pathloss value of the first TCI state is a largest estimated pathloss value among a plurality of estimated pathloss values for at least one TCI state including the first TCI state.

In some example embodiments, the information for determining the pathloss value comprises at least one measurement result of at least one reference signal.

In some example embodiments, the second apparatus further comprises: means for receiving, from the first apparatus, an indication of a capability of applying the pathloss information for performing at least one of: means for thing beam switching, or means for thing transmission to the second apparatus.

In some example embodiments, the pathloss value is associated with at least one target transmission configuration indicator (TCI) state to be switched to.

In some example embodiments, the pathloss information is included in a message indicating at least one of: an activation of a target transmission configuration indicator (TCI) state, or a switching to the target TCI state.

In some example embodiments, the pathloss information is included in a message, the message comprising an identifier of a reference signal and the pathloss value associated with the reference signal.

In some example embodiments, the pathloss value is determined by an artificial intelligence/machine learning (AI/ML) model.

In some example embodiments, the second apparatus further comprises: means for receiving, from the first apparatus, measurements of a set of reference signals; means for performing a pathloss estimation for at least one reference signal associated with at least one transmission configuration indicator (TCI) state based on the measurements; and means for determining the pathloss information based on the pathloss estimation.

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus, comprising:
at least one processor; and
at least one memory storing instructions that, when executed by the at least one processor, cause the first apparatus at least to:
receive, from a second apparatus, pathloss information for at least one of:
a beam switching of the first apparatus, or a transmission from the first apparatus to the second apparatus, wherein the pathloss information comprises at least one of: a pathloss value, or information for determining the pathloss value; and
perform, based on the pathloss value, at least one of: the beam switching, or the transmission.

2. The first apparatus of claim 1, wherein the pathloss information is associated with at least one of:
at least one reference signal,
at least one transmission configuration indicator (TCI) state for at least one of the beam switching, or the transmission,
a pathloss reference signal associated with a target TCI state to be switched to,
at least one reference signal included in a TCI state used for pathloss estimation,
a set of reference signals for pathloss estimation, or
a set of reference signals associated with at least one TCI state.

3. The first apparatus of claim 2, wherein the pathloss value comprises at least one of:
at least one absolute pathloss value for the at least one of the beam switching or the transmission,
at least one relative pathloss value relative to the at least one absolute pathloss value,
at least one relative pathloss value relative to a current pathloss value applied by the first apparatus,
at least one relative pathloss value relative to a previously provisioned pathloss value, or
at least one quantized relative pathloss value with respect to a reference pathloss value and the reference pathloss value.

4. The first apparatus of claim 3, wherein the reference pathloss value is associated with a first transmission configuration indicator (TCI) state.

5. The first apparatus of claim 4, wherein an index of first the TCI state is lowest among a plurality of indexes of a plurality of TCI states.

6. The first apparatus of claim 4, wherein the reference pathloss value is quantized with a first number of bits with a first step size, and the quantized relative pathloss value is quantized with a second number of bits with a second step size,
wherein the second number is less than or equal to the first number, and the second step size is less than or equal to the first step size.

7. The first apparatus of claim 4, wherein the reference pathloss value of the first TCI state is a largest estimated pathloss value among a plurality of estimated pathloss values for at least one TCI state including the first TCI state.

8. The first apparatus of claim 1, wherein the information for determining the pathloss value comprises at least one measurement result of at least one reference signal, and the first apparatus is further caused to:
determine the pathloss value based on the information.

9. The first apparatus of claim 1, wherein the first apparatus is further caused to:
transmit, to the second apparatus, an indication of a capability of applying the pathloss information for performing at least one of:
the beam switching, or
the transmission to the second apparatus.

10. The first apparatus of claim 1, wherein the first apparatus is further caused to:
perform the transmission to the second apparatus with a target transmission configuration indicator state associated with the beam switching, wherein at least one pathloss measurement component is excluded from a determination of a delay for the beam switching.

11. The first apparatus of claim 10, wherein the at least one pathloss measurement component is used for a determination of the delay for the beam switching if the pathloss information is not received from the second apparatus.

12. The first apparatus of claim 10, wherein the at least one pathloss measurement component comprises at least one of:
a periodicity of a pathloss reference signal,
a time duration from a measurement of a reference signal to a transmission of the pathloss reference signal, or
a time duration from coding a command from the second apparatus for the beam switching to the transmission of the pathloss reference signal.

13. The first apparatus of claim 1,
wherein the pathloss value is associated with at least one target transmission configuration indicator (TCI) state to be switched to; or
wherein the pathloss value is determined by an artificial intelligence/machine learning (AI/ML) model.

14. The first apparatus of claim 1,
wherein the pathloss information is included in a message indicating at least one of: an activation of a target transmission configuration indicator (TCI) state, or a switching to the target TCI state; or
wherein the pathloss information is included in a message, the message comprising an identifier of a reference signal and the pathloss value associated with the reference signal.

15. A second apparatus, comprising:
at least one processor; and
at least one memory storing instructions that, when executed by the at least one processor, cause the second apparatus at least to:
transmit, to a first apparatus, pathloss information for at least one of: a beam switching of the first apparatus, or a transmission from the first apparatus to the second apparatus, wherein the pathloss information comprises at least one of: a pathloss value for the beam switching, or information for determining the pathloss value.

16. The second apparatus of claim 15, wherein the pathloss information is associated with at least one of:
at least one reference signal,
at least one transmission configuration indicator (TCI) state for at least one of the beam switching, or the transmission,
a pathloss reference signal associated with a target TCI state to be switched to,
at least one reference signal included in a TCI state used for pathloss estimation,
a set of reference signals for pathloss estimation, or
a set of reference signals associated with at least one TCI state.

17. The second apparatus of claim 15, wherein the pathloss value comprises at least one of:
at least one absolute pathloss value for the at least one of the beam switching or the transmission,
at least one relative pathloss value relative to the at least one absolute pathloss value,
at least one relative pathloss value relative to a current pathloss value applied by the first apparatus,
at least one relative pathloss value relative to a previously provisioned pathloss value, or
at least one quantized relative pathloss value with respect to a reference pathloss value and the reference pathloss value.

18. The second apparatus of claim 16, wherein the pathloss value comprises at least one of:
at least one absolute pathloss value for the at least one of the beam switching or the transmission,
at least one relative pathloss value relative to the at least one absolute pathloss value,
at least one relative pathloss value relative to a current pathloss value applied by the first apparatus,
at least one relative pathloss value relative to a previously provisioned pathloss value, or
at least one quantized relative pathloss value with respect to a reference pathloss value and the reference pathloss value.

19. The second apparatus of claim 18, wherein the reference pathloss value is associated with a first transmission configuration indicator (TCI) state.

20. A method comprising:
receiving, at a first apparatus from a second apparatus, pathloss information for at least one of: a beam switching of the first apparatus, or a transmission from the first apparatus to the second apparatus, wherein the pathloss information comprises at least one of: a pathloss value, or information for determining the pathloss value.
performing, based on the pathloss value, at least one of: the beam switching, or the transmission.
